(19) United States
(12) Patent Application Publication
(10) Pub. No.: US 2014/0003654 A1
(43) Pub. Date: Jan. 2, 2014

(54) METHOD AND APPARATUS FOR IDENTIFYING LINE-OF-SIGHT AND RELATED OBJECTS OF SUBJECTS IN IMAGES AND VIDEOS

(71) Applicant: Jerome Beaurepaire, Berlin (DE)

(72) Inventor: Jerome Beaurepaire, Berlin (DE)

(73) Assignee: Nokia Corporation, Espoo (FI)

(21) Appl. No.: 13/538,301

(22) Filed: Jun. 29, 2012

(51) Int. Cl. G06K 9/78

(52) U.S. Cl. 382/103

(57) ABSTRACT

An approach is provided for identifying line-of-sight and related objects of subjects in images and videos. An identification platform causes, at least in part, processing and/or facilitating a processing of the at least one image, sensor data, or a combination thereof to determine (a) at least one line of sight associated with at least one subject in the at least one image, (b) at least one object in the at least one line of sight, or (c) a combination thereof. The identification platform then causes, at least in part, an association of the at least one line of sight, the at least one object, or a combination thereof with the at least one image.

### BACKGROUND

Service providers and device manufacturers (e.g., wireless, cellular, etc.) are continually challenged to deliver value and convenience to consumers by, for example, providing compelling network services. One area of development has been the integration of location data and images to enable services that associate metadata with captured images, for instance, geotagging. Such geospatial metadata may include vast amounts of useful information, including, but not limited to latitude and longitude coordinates, altitude, bearing, and points of interest. For example, this information may be integrated with other services to provide value to image data users. However, even with the availability of associated location data and images, their use with respect to geospatial metadata has generally been limited to information derived only from an image capture device without consideration for image subjects and/or the environment depicted. Accordingly, service providers and device manufacturers face significant challenges to enabling an added dimension of subject/environment data derived from a captured image and associated devices.

### SOME EXAMPLE EMBODIMENTS

Therefore, there is a need for an approach for identifying line-of-sight and related objects of subjects in images and videos.

According to one embodiment, a method comprises processing and/or facilitating a processing of the at least one image, sensor data, or a combination thereof to determine (a) at least one line of sight associated with at least one subject in the at least one image, (b) at least one object in the at least one line of sight, or (c) a combination thereof. The method further comprises causing, at least in part, an association of the at least one line of sight, the at least one object, or a combination thereof with the at least one image.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of the at least one image, sensor data, or a combination thereof to determine (a) at least one line of sight associated with at least one subject in the at least one image, (b) at least one object in the at least one line of sight, or (c) a combination thereof. The apparatus is further caused to facilitate, at least in part, an association of the at least one line of sight, the at least one object, or a combination thereof with the at least one image.

According to another embodiment, a computer-readable storage medium carries one or more sequences of one or more instructions which, when executed by one or more processors, cause, at least in part, an apparatus to process and/or facilitate a processing of the at least one image, sensor data, or a combination thereof to determine (a) at least one line of sight associated with at least one subject in the at least one image, (b) at least one object in the at least one line of sight, or (c) a combination thereof. The apparatus is further caused to facilitate, at least in part, an association of the at least one line of sight, the at least one object, or a combination thereof with the at least one image.

According to another embodiment, an apparatus comprises means for processing and/or facilitating a processing of the at least one image, sensor data, or a combination thereof to determine (a) at least one line of sight associated with at least one subject in the at least one image, (b) at least one object in the at least one line of sight, or (c) a combination thereof. The apparatus further comprises means for causing, at least in part, an association of the at least one line of sight, the at least one object, or a combination thereof with the at least one image.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of identifying line-of-sight and related objects of subjects in images and videos, according to one embodiment;

FIG. 2 is a diagram of the components of an identification platform capable of identifying line-of-sight and related objects of subjects in images and videos, according to one embodiment;

FIGS. 3A-3H is a flowchart of a process for identifying line-of-sight and related objects of subjects in images and videos, according to various embodiment;

FIGS. 4A-4B are diagrams of subject capture interactions for identifying line-of-sight and related objects of subjects in images and video, according to various embodiments;

FIG. 5 is a diagram of user equipment utilized in the processes of FIG. 3, according to various embodiments;

FIGS. 6A-6D are diagrams of user interfaces utilized in the processes of FIG. 3, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for identifying line-of-sight and related objects of subjects in images and videos are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

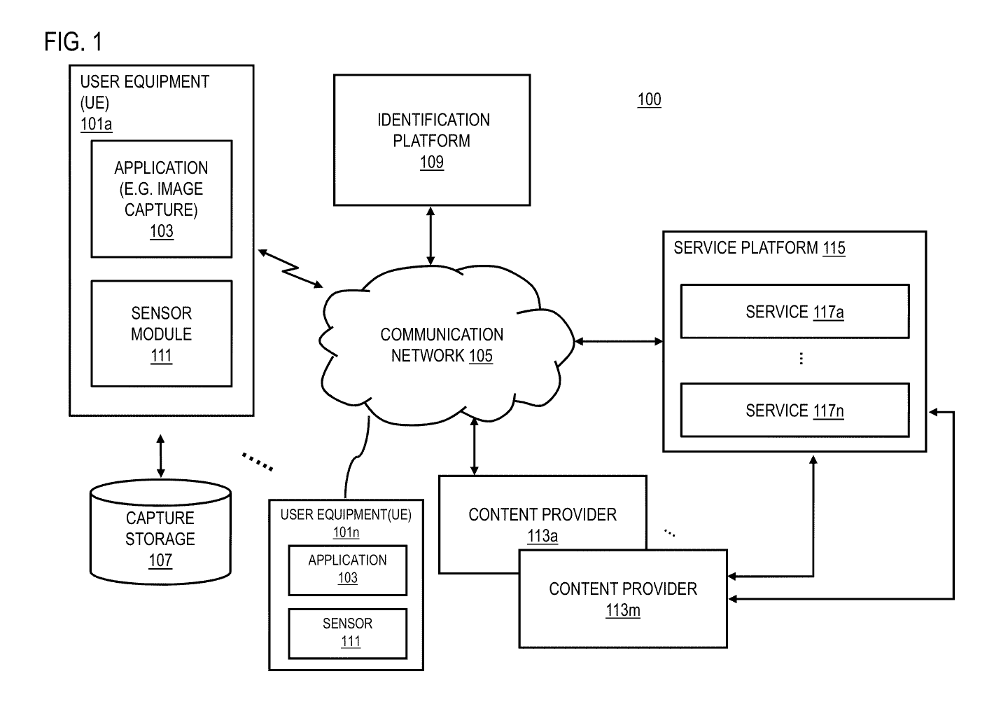

FIG. 1 is a diagram of a system capable of identifying line-of-sight and related objects of subjects in images and videos, according to one embodiment. Traditionally, captured images may be geotagged to provide location information for the image, but a geotag is only related to the geographic position of a user's device at the moment of the image capture. As a result, the information captured in the image is missing at least one dimension of information. Upon review of captured images, the reviewer is limited in that no information is necessarily associated with the captured image indicating what image subjects were looking at the moment the image was captured.

To address this problem, a system 100 of FIG. 1 introduces the capability to determine a captured image subject's line-of-sight and at least one candidate object in the line-of-sight of a subject at the moment the image was captured. In this way, users no longer need to render a post-image capture assumption regarding what an image subject may have been looking at when image was captured or independently look for information about a candidate object point of interest, which may or may not be represented in the image. Further, users no longer need to attempt to capture multiple sequential images in hope of capturing what an image subject may have been previously looking at to associate appropriate images at some later time. Instead, a user may process sensor data to determine the line-of-sight of a subject and query for possible candidate objects in the determined line-of-sight to know what a user was looking at when the image was captured.

The system 100 may build on the ready availability of location and candidate object information, and introduce the capability to apply the availability to elements within an image. The term “image” refers to pictures, videos, renderings (e.g., augmented reality renderings, virtual reality renderings), virtual worlds, and/or any other graphical depictions of one or more locations. In one embodiment, it is contemplated that the locations can be real-world locations or virtual locations (e.g., in a virtual world such as a gaming world or other virtual reality simulation). Moreover, the images can be presented in two-dimensions or three-dimensions.

More specifically, the system 100 processes one or more images (e.g., photographs, image streams, videos, pictures, etc.) to determine various elements within an image. In one embodiment, the picture or video may be a panoramic view of a capture environment. In this scenario, elements within the capture environment may be buildings or other landmarks. In some embodiments, the location information of the elements is previously embedded in the image. In other embodiments, location information is queried via an application native to the imaging device or via a connected source and determined based on further processing of the image data.

As shown in FIG. 1, the system 100 comprises a user equipment (UE) 101 having connectivity to identification platform 109 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, an image is processed in conjunction with sensor data derived from one or more imaging devices to determine the line-of-sight of an image subject, an object in the line-of-sight of a subject, or a combination thereof. In an exemplary situation, at least one object is determined via a processing of sensor data, a querying for information related to the environment depicted in a captured image, a synchronized transmitted signal from one or more other devices, a synchronized image capture from one or more other devices, or a combination thereof. In such embodiments, captured data may be any image, including, but not limited to still images and dynamic images (e.g., video). In addition, although various embodiments are discussed with respect to captured data that are one or more images, it is contemplated that any captured or recorded data (e.g., audio data) may be used with the embodiments described herein. As such, sensor data can include audio data, including, but not limited to speech recognition data, that can be used to determine the at least one object in the at least one line-of-sight of a subject. In such an embodiment, transmission of synchronization signals between multiple devices function to, at least in part, trigger an image capture from one or more other devices.

In a further embodiment, an imaging device having at least a secondary camera capable of capturing more than one image simultaneously or sequentially according to a user's needs is employed. In such an embodiment, at least one additional camera captures one or more other images. Multiple images are processed in conjunction with sensor data derived from one or more imaging devices to determine the line-of-sight of an image subject, an object in a line-of-sight of the subject, or a combination thereof. In an exemplary situation, at least one object is determined via a processing of sensor data, a querying for information related to the environment depicted in a captured image, a synchronized transmitted signal from one or more other devices, a synchronized image capture from one or more other devices, or a combination thereof. In such embodiments, captured data may be any image, including, but not limited to still images and dynamic images (e.g., video). In such an embodiment, transmission of synchronization signals function to, at least in part, capture an image from one or more paired devices. By way of example, an imaging device having multiple cameras may function to capture one or more subjects and one or more objects in a field of view defined by a line of sight of one or more subject.

In another further embodiment, guidance information is transmitted to one or more devices in conjunction with image processing and sensor data instructing one or more users of one or more imaging devices. In such an embodiment, guidance information instructs a user to manipulate one or more image capture devices to configure one or more images. Such guidance information is presented in a user interface of at least one imaging device to capture at least one object as determined via a processing of sensor data, a querying for information related to the environment depicted in a captured image, a synchronized transmitted signal from one or more other devices, a synchronized image capture from one or more other devices, or a combination thereof. Likewise, in an exemplary situation, a subject's field of view is processed, at least in part, to determine guidance information.

In another further embodiment at least one image having multiple subjects is processed in conjunction with processed sensor data derived from one or more devices to determine a line-of-sight of one or more subjects, an object in the line-of-sight of a subject, or a combination thereof. By way of example, data associated with one or more subjects in one or more captured images derives, at least in part, from a processing of sensor data to determine, at least in part, at least one location, at least one tilt angle, at least one field-of-view, or a combination thereof of at least one imaging device, at least one subject, or a combination thereof. Likewise, in an exemplary situation, processed data includes information posted, stored, published, featured or otherwise broadcast to one or more subscribers of a service, i.e., a social networking or location service. In some embodiments, environmental characteristics (e.g., weather, ambient light levels, ambient sound levels, etc.) may be used to further determine at least one line-of-sight associated with at least one subject in the at least one image, at least one object in the at least one line-of-sight, or a combination thereof.

By way of example, determination of at least one object in the at least one line-of-sight may employ a map application to determine location information. For example, location information derives from a model of an element (e.g. a three-dimensional map made from a physical scan), wherein an object is identified by matching the object to a model, then location information is determined from data offered by the model. In a further embodiment, image recognition is used to identify the at least one object in the at least one line-of-sight. In another embodiment, a more interactive method of prompting a user to select an object in a subject's line-of-sight is employed. A map application such as an online map application may be employed to determine location information of an object. More specifically, the location can be determined by a triangulation system such as a GPS system, assisted GPS (A-GPS), wireless local area network triangulation, or other location extrapolation technologies. Standard GPS and A-GPS systems can use satellites to pinpoint the location (e.g., longitude, latitude, and altitude) of the element. GPS coordinates can provide finer detail as to the location of the element.

By way of example, image capture subjects may employ wearable devices, head mounted devices (e.g., glasses or alternative devices), hand-held devices (e.g., a mobile phone or alternative devices), or any paired device to communicate with an image capture device to cause a transmission of at least one synchronization signal. In such an embodiment, a synchronization signal causes, at least in part, a capture of at least one other image. The synchronization signal may cause, at least in part, an association of the at least one other image with at least one captured image.

In one embodiment, the image processing also employs various data recognition techniques for analyzing images. This includes, for example, object recognition and facial recognition. Any known and still developing protocols and algorithms may be employed. It is noted that image capturing may operate in connection with an image capturing or image viewing application. If other types of captured data (e.g., sound) are to be processed, one or more devices can be configured with the appropriate sensors (e.g., a microphone) and/or applications. In such embodiments, the application may be a dedicated application operable by one or more devices, a browser based application, or the like. Also, the image capture application may enable the review of newly captured images as well as images captured in the past. Any means through which the user can review, acquire, or recall images are within scope of the exemplary embodiments herein. In another example, one or more devices may process contextual sensor information (e.g., accelerometer data, compass data, gyroscope data, etc.) to determine a direction or mode of dynamic subject movement, line-of-sight, or a combination thereof.

By way of example, the UE 101, identification platform 109, content provider 113, and service platform 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

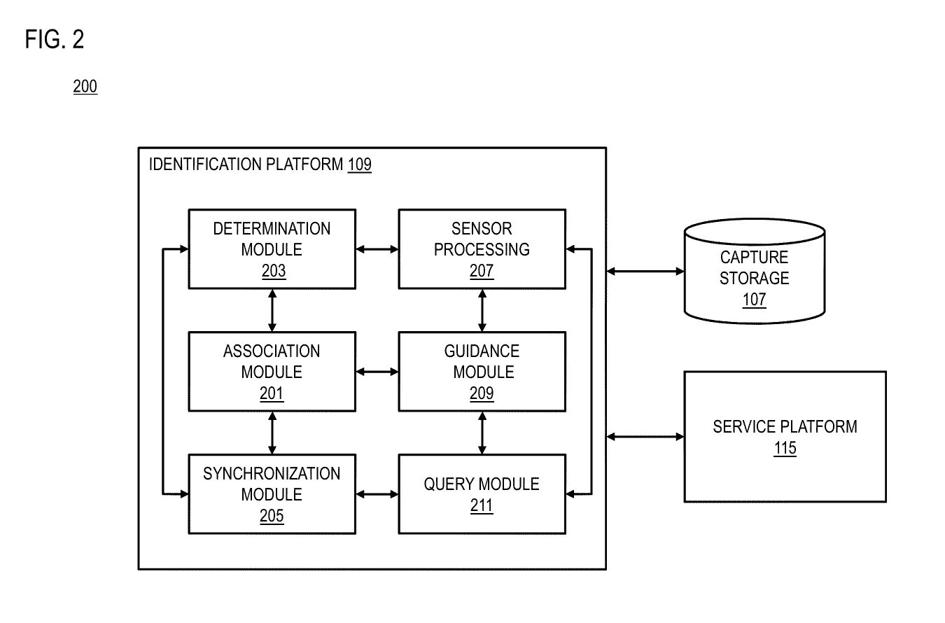

FIG. 2 is a diagram of the components of identification platform 109, according to one embodiment. By way of example, the identification platform includes one or more components for identifying line-of-sight and related objects of subjects in images and videos. It is contemplated that the functions of these components may be combined in one or more components or performed by other components of equivalent functionality. In this embodiment, the identification platform 109 includes an association module 201, a determination module 203, a synchronization module 205, a sensor processing module 207, a guidance module 209, and a query module 211.

The association module 201 causes, at least in part, an association of at least one line-of-sight of one or more subjects, at least one object in a the line-of-sight of a subject, or a combination thereof with at least one image. By way of example, the image is associated with metadata for representing the line of sight of one or more subjects or related line-of-sight candidate objects depicted in an image or in the line-of-sight of sight of a subject. In addition, one or more user or auto-generated tags may be packaged as metadata for association with the image. The association module 201 may function by creating collections of multiple images. Further, information derived from transmitted signals from one or more other devices may be associated with images. In some embodiments the association module 201 derives data from information posted, stored, published, featured or otherwise broadcast to one or more subscribers of a service, i.e., a social networking, location service, online map service, or a combination thereof. In a further embodiment, the association module 201 provides information from determined candidate objects and inputs specifying the at least one object from among one or more candidate object. In another further embodiment, the association module causes an association between at least one image and queried information related to an environment depicted in the at least one image, wherein the information includes real-time information, historical information, or a combination thereof.

The determination module 203 processes information from the image capture device, one or more other devices, or a combination thereof to determine at least one line-of-sight associated with at least one subject in the at least one image, at least one object in the at least one line-of-sight, or a combination thereof. By way of example, determination module may process images via capture storage. The determination module 203 may detect user interaction with a user interface generated by the UE 101, application 103, and/or the identification platform 109. Application 103 employs a UE function, such as an image capture application for providing image information to at least determination module 203. The determination module 203 may work in conjunction with the identification platform 109, wherein the determination module 203 identifies a point on the user interface that the user selects, such as by brushing, clicking, or touching the screen of UE 101. The identification platform 109 may then correlate point(s) selected with an element within an image, and consequently, find object information associated with that candidate object. As such, determination module 203 may process any input from one or more devices for specifying at least one object from among one or more candidate objects.

The synchronization module 205 communicates (i.e., causes a transmission signal, receives a transmission signal) with one or more other devices causing, at least in part, a determination of sensor data. As such, the synchronization module 205 may cause, at least in part, a capture of at least one other image to be associated with a captured image by the association module 201.

The sensor processing module 207 functions to determine line-of-sight and related objects by processing sensor data from an imaging device, one or more other devices, or a combination thereof. Such sensor data may be transmitted via synchronization signals from one or more other devices. Furthermore, the sensor processing module 207 functions to determine, at least in part, at least one location, at least one tilt angle, at least one field-of-view, or a combination thereof of the at least one imaging device, the one or more other devices, or a combination thereof provided, in part, via sensor module 111. Further, to determine related objects in the line-of-sight of one or more subjects, location information may be pre-determined and embedded in the image data. In this method, selecting the candidate object within an image may directly retrieve object information without employing additional steps. The possible use of a magnetometer (compass) integrated in an imaging device, one or more other devices, or a combination thereof can help in determining the direction the subject is facing, or a subject's line-of-sight and thus aids in determining a related object via a map overlay.

The guidance module 209 instructs a user to manipulate one or more image capture devices to configure one or more images. Guidance information provides information to influence image configuration to account for candidate objects in a line-of-sight of a subject. Such guidance information is presented in a user interface of at least one imaging device to capture at least one object as determined via a processing of sensor data, a querying for information related to the environment depicted in a captured image, a synchronized transmitted signal from one or more other devices, a synchronized image capture from one or more other devices, or a combination thereof. Likewise, in an exemplary situation, guidance module 209 functions to process a field of view of a subject, at least in part, to determine guidance information.

The query module 211 queries for information related to an environment depicted in the captured image, wherein the information includes real-time information, historical information, or a combination thereof. Such information is processed by the query module 211 to determine at least one line-of-sight of at least one subject, at least one related object in at least one line-of-sight, or a combination thereof. Query module 211 function to effectuate a query via communication network 105 of any available network component, including, but not limited to one or more available User Equipment (e.g., 101, 101n), content provider 113a, service platform 115, or a combination thereof. In an exemplary situation, query module 211 queries data including information posted, stored, published, featured or otherwise broadcast to one or more subscribers of a service, i.e., a social networking or location service. By way of example, query module 211 queries data via any offline or hosted/online applications or services for storing and sharing event information utilizing information derived from captured data (e.g., image data, audio data, video data, etc.).

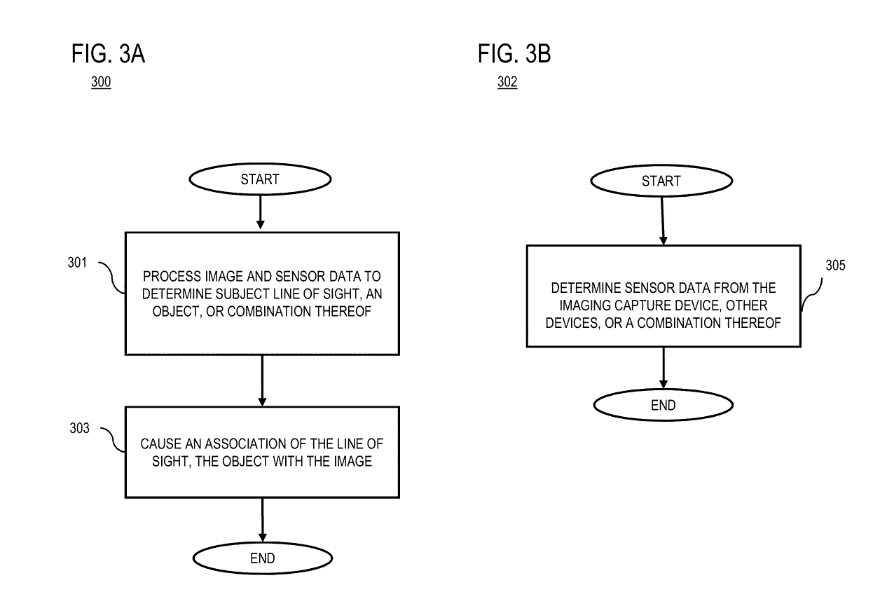

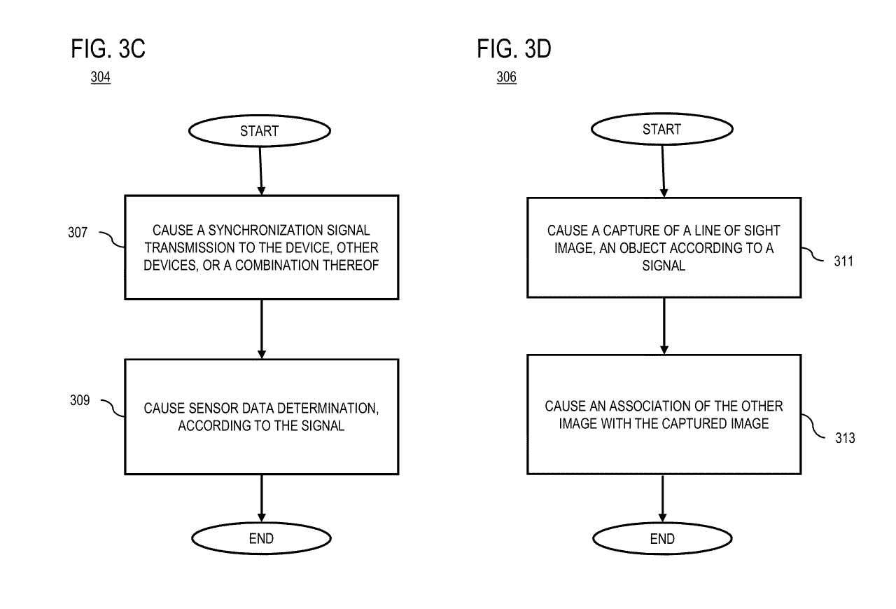

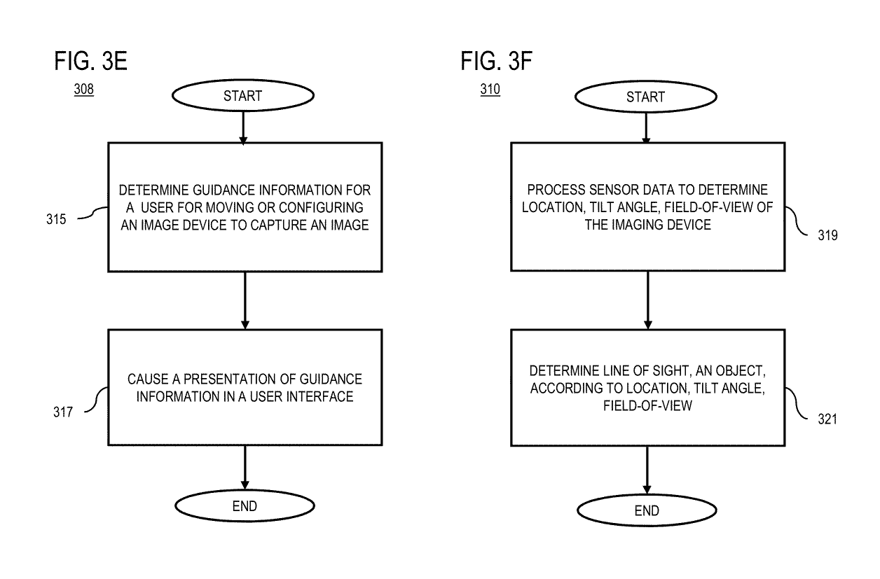

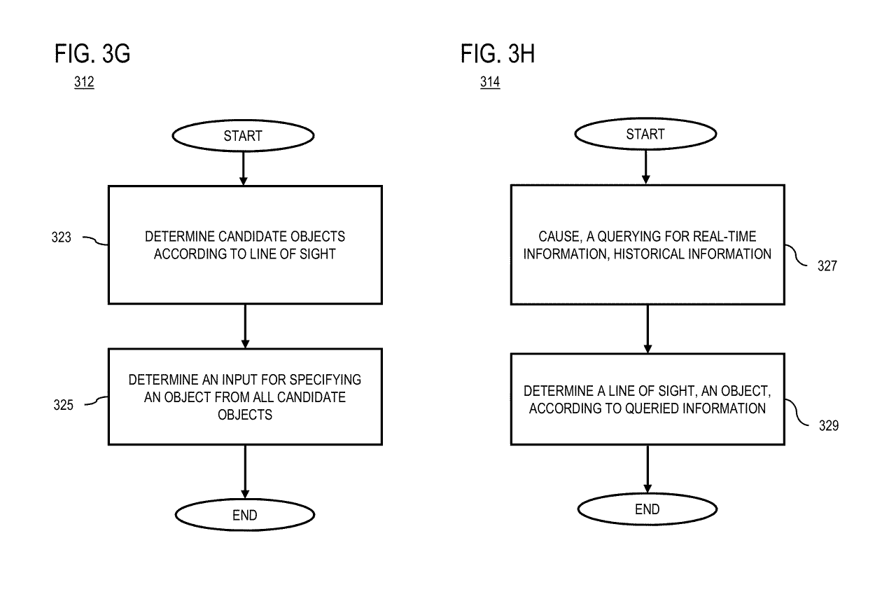

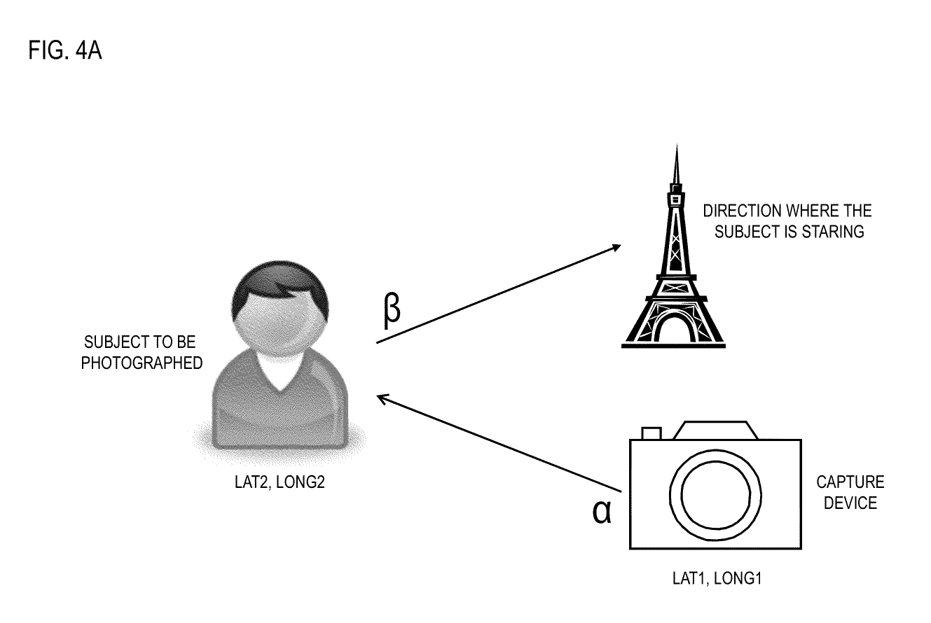

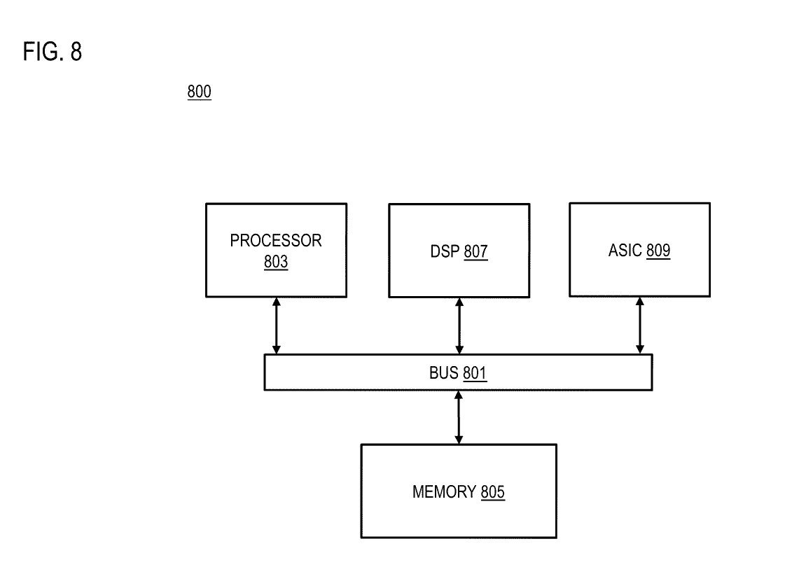

FIG. 3 is a flowchart of a process for identifying line-of-sight and related objects of subjects in images and videos, according to one embodiment. In one embodiment, the identification platform 109 performs the process 300 and is implemented in, for instance, a chip set including a processor and a memory as shown in FIG. 8. In step 301, the identification platform 109 processes and/or facilitates a processing of the at least one image, sensor data, or a combination thereof, wherein determination module 203 and association module 201 function coordinately to determine at least one line-of-sight associated with at least one subject in the at least one image, at least one object in the at least one line-of-sight, or a combination thereof. For example, identification platform 109 causes, at least in part, an association of the at least one line-of-sight, the at least one object, or a combination thereof with the at least one image (step 303). For instance, at least one object is determined via a processing of sensor data, a querying for information related to the environment depicted in a captured image, a synchronized transmitted signal from one or more other devices, a synchronized image capture from one or more other devices, or a combination thereof. In such embodiments, captured data may be any image, including, but not limited to still images and dynamic images (e.g., video). In addition, although various embodiments are discussed with respect to captured data that are one or more images, it is contemplated that any captured or recorded data (e.g., audio data) may be used with the embodiments described herein.

After processing of the at least one image, sensor data, or a combination thereof to determine line-of-sight and related objects of subjects in the at least one image, sensor processing module 207 and determination module 203 function coordinately to determine the sensor data from an imaging device capturing the at least one image, one or more other devices associated with the at least one subject, or a combination thereof (step 305). For instance, multiple connected user equipment (101, 101n) communicate sensor data between multiple users, which may create a coordinated action.

In step 307, synchronization module 205 causes, at least in part, a transmission of at least one synchronization signal to the device, the one or more other devices, or a combination thereof. Determination module 203 causes, at least in part, a determination of the sensor data based, at least in part, on the at least one synchronization signal (step 309). By way of example, transmission of synchronization signals function to, at least in part, capture an image from any paired devices or cameras.

In step 311, identification platform 109, sensor processing platform 207, determination module 203, and synchronization module 205 may work together to cause, at least in part, a capture of at least one other image of the at least one line-of-sight, the at least one object, or a combination based, at least in part, on the at least one synchronization signal. Association module 201 in step 313 causes, at least in part, an association of the at least one other image with the at least one image.

In step 315, guidance module 209 and determination module 203 function coordinately to determine guidance information for instructing a user of the at least one imaging device, the one or more other devices, or a combination thereof for configuring one image device, the one or more other devices, or a combination thereof to cause the capture of at least one other image. In such an embodiment, guidance information instructs a user to manipulate one or more image capture devices to configure one or more images. Such guidance information is presented via a user interface of at least one imaging device to capture at least one object as determined via a processing of sensor data, a querying for information related to the environment depicted in a captured image, a synchronized transmitted signal from one or more other devices, a synchronized image capture from one or more other devices, or a combination thereof. Likewise, in an exemplary situation, a subject's field of view is processed, at least in part, to determine guidance information. After the determination of guidance information, identification platform 109 functions to cause, at least in part, a presentation of the guidance information in a user interface of the at least one imaging device, the one or more other devices, or a combination thereof (step 317).

In step 319, identification platform 109 and sensor processing module 207 function coordinately to process and/or facilitate a processing of the sensor data to determine, at least in part, at least one location, at least one tilt angle, at least one field-of-view, or a combination thereof of the at least one imaging device, the one or more other devices, or a combination thereof. In one embodiment, the image processing also employs various data recognition techniques for analyzing images. This includes, for example, object recognition and facial recognition. Any known and still developing protocols and algorithms may be employed. It is noted that the image capturing may operate in connection with an image capturing or image viewing application. If other types of captured data (e.g., sound) are to be processed, one or more devices can be configured with the appropriate sensors (e.g., a microphone) and/or applications. In such embodiments, the application may be a dedicated application operable by one or more devices, a browser based application, or the like. Also, the image capture application may enable the review of newly captured images as well as images captured in the past. Any means through which the user can review, acquire, or recall images are within scope of the exemplary embodiments herein. In another example, one or more devices may process sensed contextual information (e.g., accelerometer data, compass data, gyroscope data, etc.) to determine a direction or mode of dynamic subject movement, line-of-sight, or a combination thereof. Further, determination module 203 functions in part to determine the at least one line-of-sight, the at least one object, or a combination thereof based, at least in part, on the at least one location, the at least one tilt angle, the at least one field-of-view, or a combination thereof (step 321).

In step 323 identification platform 109, sensor processing platform 207, determination module 203, and synchronization module 205 may work together to determine one or more candidate objects based, at least in part, on the at least one line-of-sight of a subject. Further, guidance module 209, query module 211 and determination module 203 may work together to determine an input for specifying the at least one object from among the one or more candidate objects (step 325).

In step 327, identification platform 109 and query module 211 function coordinately to cause, at least in part, a querying for information related to an environment depicted in the at least one image, wherein the information includes real-time information, historical information, or a combination thereof. In an exemplary embodiment, imaging device user or one or more subjects employ query module 211 to implement a query to acquire information regarding a related object in the line-of-sight of one or more image subjects. Such information may be associated via association module 201 with an image. Further, determination module 203 functions to determine the at least one line-of-sight, the at least one object, or a combination thereof based, at least in part on the information (step 329).

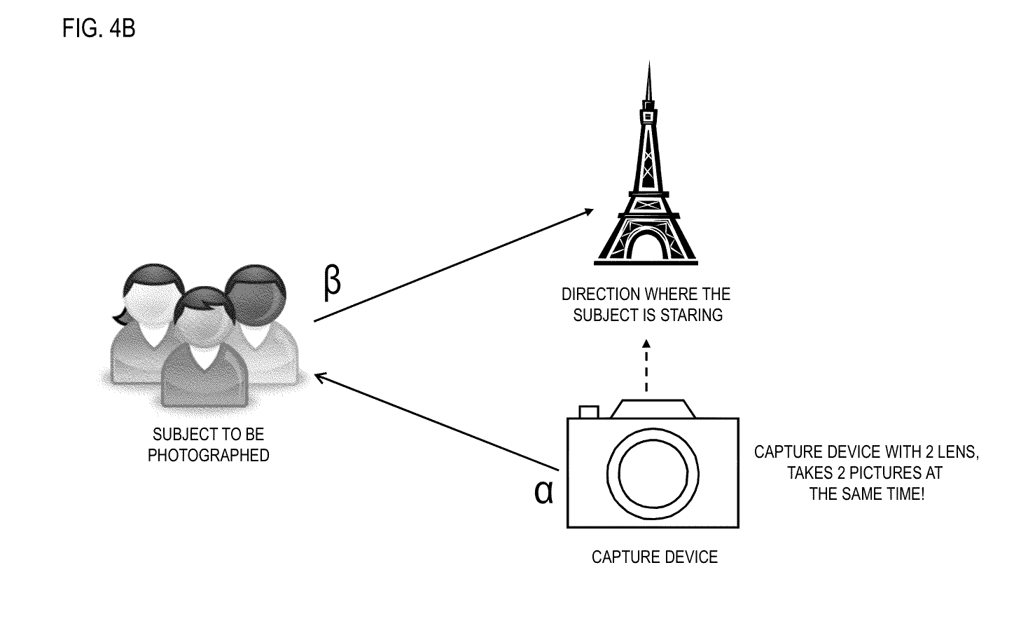

FIGS. 4A-4B are diagrams of subject capture interactions for identifying line-of-sight and related objects of subjects in images and video, according to various embodiments. In one embodiment, a master imaging device captures an image. For example, the imaging device may be paired to allow transmission of a synchronization signal between the imaging device and the one or more devices employed by an image subject. The imaging device may trigger a synchronization signal in the paired one or more devices to capture one or more other images of one or more related objects in the line-of-sight of one or more subjects. By way of example, as depicted in FIG. 4A, capture device sensor data α (i.e., location, tilt angle, field of view, or a combination thereof) may be determined via a sensor or user equipment application. Furthermore, subject sensor data β may be calculated according to collected known parameters of the capture device. In a further embodiment subject sensor data β may be calculated according to an image subject's captured gaze via a gaze tracking algorithm, image recognition algorithm, determined device sensor data α, or a combination thereof.

By way of example, by processing all available sensor data, position information, capture device sensor data α, and subject sensor data β, determination module 203 may function to determine at least one subject line-of-sight, at least one object in the at least one line-of-sight, or a combination thereof to determine what an image subject was observing when the image was captured. In a further embodiment, sensor data is processed to trigger one or more synchronized devices to capture one or more other images, wherein the images capture a related object in the line-of-sight of a subject. As such, sensor data may be processed to query for information related to the line-of-sight of a subject.

By way of example, a sensor data query may return possible objects in the line-of-sight of one or more subjects. In such an example, a user may choose from a ranked list of possible objects to cause an association, at least in part, between an image, a line-of-sight of one or more subjects, at least one object in the line-of-sight, or a combination thereof. By way of example, an algorithm may be employed to determine a ranked list of possible objects in the line-of-sight of a subject. In a further example, user input from one or more devices or connected services may be employed alone, or in combination with an algorithm to determine a ranked list of possible objects in the line-of-sight of a subject. Image data may be associated with an image automatically according to algorithm parameters, user input, or a combination thereof.

In a further embodiment, wherein multiple subjects are captured within a single image, determination module 203 may process the line-of-sight of each subject individually. Respective lines-of-sight of each subject may be extrapolated to determine coordinating related objects in each line-of-sight. For example, it may be determined that each subject is looking in the same direction, thus having the same or similar line of sight according to calculated sensor data. In a further example, it may be determined that each subject is looking in a different or unique direction, thus having multiple unique lines-of-sight according to calculated sensor data. As such, one or more objects may be in the various lines-of-sight. Related objects may be determined based on algorithm parameters, user inputs, or a combination thereof.

In a further embodiment, as depicted in FIG. 4B, an imaging device may employ multiple cameras capable of capturing more than one image simultaneously or sequentially according to a user's needs. In such an embodiment, any additional cameras capture at least one other image. Multiple images are processed in conjunction with processed sensor data derived from one or more imaging devices to determine a line-of-sight of a subject, an object in the line-of-sight of a subject, or a combination thereof. As previously noted, capture device sensor data α (i.e., location, tilt angle, field of view, or a combination thereof) may be determined via a sensor. In one embodiment, subject sensor data β may be calculated according to known parameters of the capture device. In a further embodiment subject sensor data β may be calculated according to an image subject's captured gaze via a gaze tracking algorithm, image recognition algorithm, determined device sensor data α, or a combination thereof. By way of example, by processing all available sensor data, position information, capture device sensor data α, and subject sensor data β, determination module 203 may function to determine at least one subject line-of-sight, at least one object in the at least one line-of-sight, or a combination thereof to determine what an image subject was observing when the image was captured.

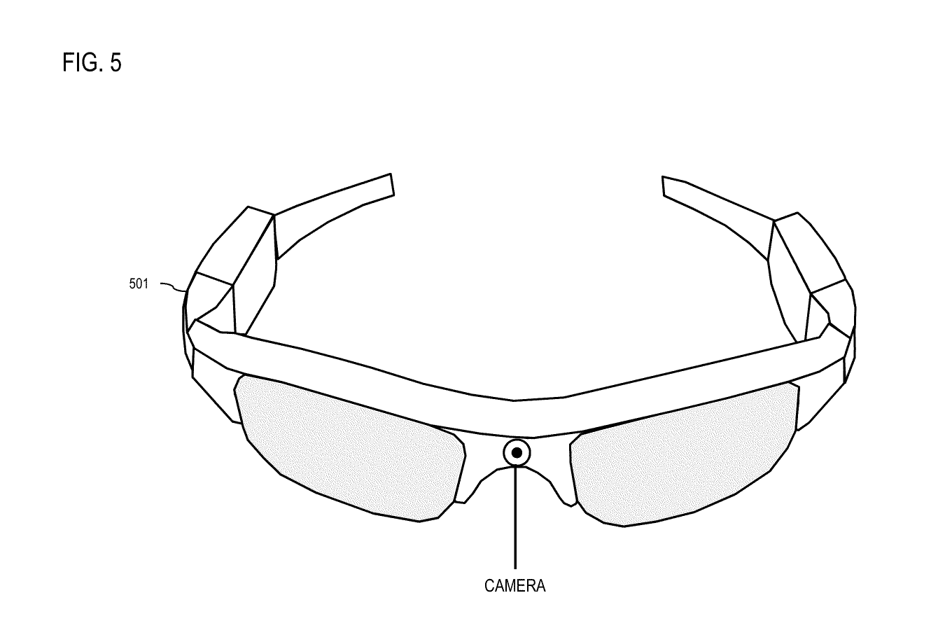

FIG. 5 is a diagram of user equipment utilized in the processes of FIG. 3, according to various embodiments. By way of example, image capture subjects may employ wearable devices, head mounted devices 501, hand-held devices (e.g., a mobile phone or alternative devices), or any synchronization device to communicate with an imaging device to cause a transmission of at least one synchronization signal. In such an embodiment, a synchronization signal causes, at least in part, a capture of at least one other image. The synchronization signal may cause, at least in part, an association of the at least one other image with at least one captured image. Beyond transmitting or receiving a synchronization signal, head mounted device 501, may be employed as a secondary camera capable of capturing more than one image simultaneously or sequentially according to a user's needs. In such an embodiment, an additional camera may capture at least one other image. Multiple images are processed in conjunction with processed sensor data derived from one or more imaging devices to determine a line-of-sight of an image subject, an object in the line-of-sight of a subject, or a combination thereof.

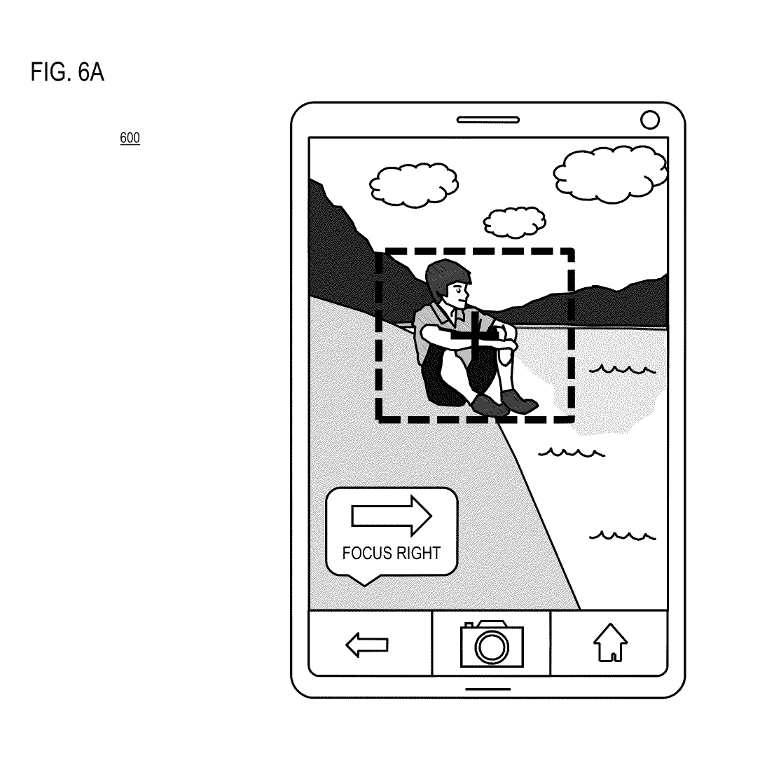

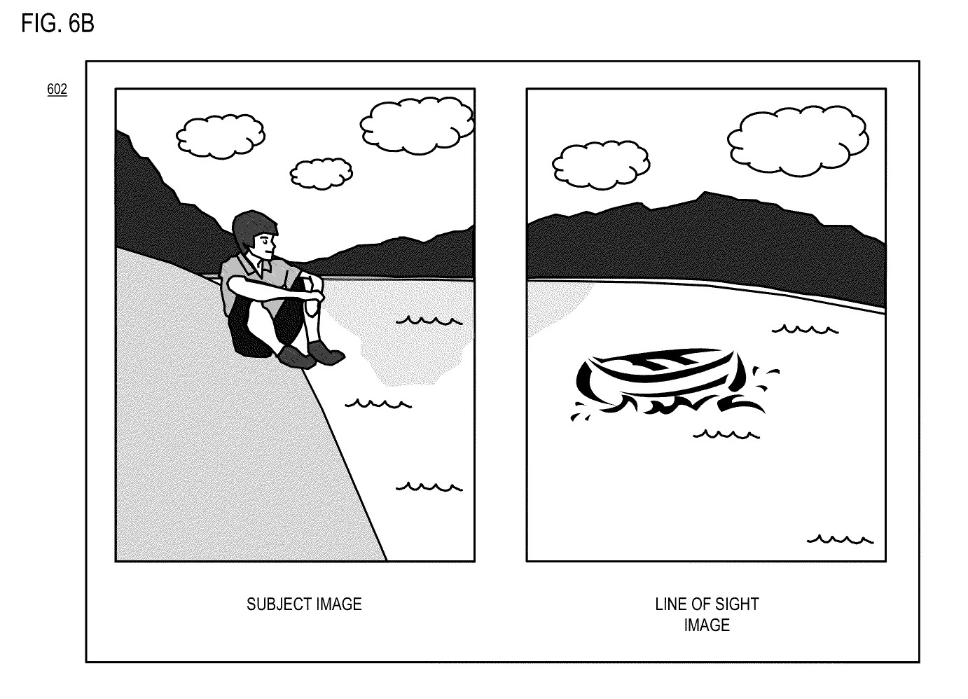

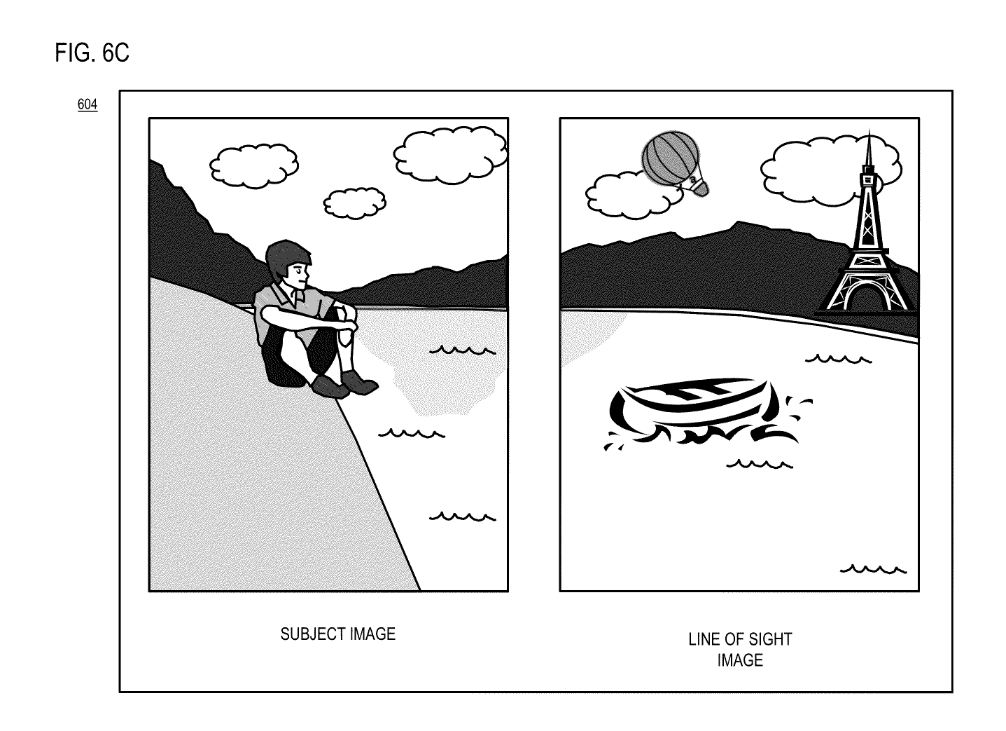

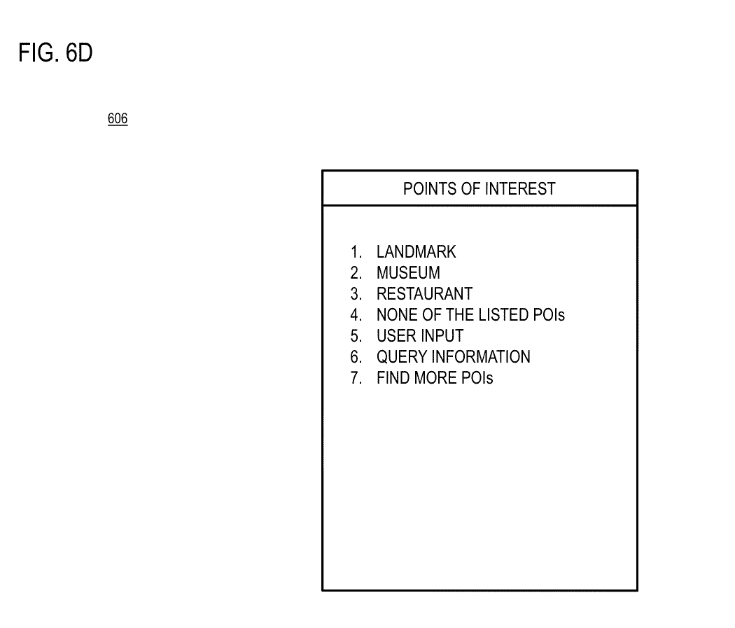

FIGS. 6A-4D are diagrams of user interfaces utilized in the processes of FIG. 3, according to various embodiments. FIG. 6A depicts a user interface of exemplary embodiment system 600 that employs, in part, guidance information via guidance module 204. Guidance information employs sensor data from an imaging device, one or more other devices, or a combination thereof. By way of example, imaging device user prompts are provided to configure images according to a subject line-of-sight, one or more user inputs from one or more users, synchronization signals, queried information, a social networking service, location service, an online map service, or a combination thereof. In such an example, user prompts are presented via an imaging device user, prior to image capture, as an indication to a user to alter or configure an image to capture an object related to a subject line-of-sight. For example, one or more other devices may transmit a signal to the imaging device prompting the user to move the camera to also capture an object of interest in the image. Further, as depicted in FIG. 6A, guidance information may be presented to the imaging device user to “FOCUS RIGHT” to capture an object in the line-of-sight of a subject (e.g., a mountain on the far bank of the depicted river).

FIG. 6B depicts a user interface of exemplary embodiment system 602 illustrating, in part, an image association. “SUBJECT IMAGE” depicts an image from an imaging device. “LINE OF SIGHT IMAGE” depicts an associated image that was captured by a sequential image capture by the imaging device, an imaging device secondary camera, or one or more other devices that may or may not be associated with one or more subjects. In such an embodiment, “LINE OF SIGHT IMAGE” is an associated image intended to capture one or more objects in the line-of-sight of one or more subjects. In an exemplary embodiment, an image subject is looking off into a river at the time an imaging device user captured the image. As previously discussed, subject line-of-sight sensors, one or more user inputs from one or more users, synchronization signals, queried information, a social networking service, location service, an online map service, or a combination thereof are employed to capture an exemplary “LINE OF SIGHT IMAGE”. For example, one or more users may initiate an information query via a paired offline or online service with one or more paired devices to determine events corresponding temporally and spatially with the image capture. For instance, at the time and location of an image capture, social network services may indicate that one or more connected users were in the line-of-sight of an image subject. Such an event from an information query may be associated with an image, providing a candidate object related to a subject line-of-sight.

FIGS. 6C and 6D depict corresponding user interfaces. FIG. 6C depicts exemplary embodiment system 606 illustrating, in part, an image association. FIG. 6D depicts ranked POINTS OF INTEREST user interface 608 illustrating, the corresponding POINTS OF INTEREST determined according to captured objects in the corresponding “LINE OF SIGHT IMAGE” of FIG. 6C. “SUBJECT IMAGE” depicts an image from an imaging device. “LINE OF SIGHT IMAGE” depicts an associated image that was captured via a sequential image capture by the imaging device, an imaging device secondary camera, or one or more other devices that may or may not be associated with one or more subjects. In such an embodiment, a user may choose from a ranked list of possible objects to cause an association, at least in part, between a “SUBJECT IMAGE” and “LINE OF SIGHT IMAGE” image. By way of example, an algorithm may be employed to determine a ranked list of possible objects in the line-of-sight of a subject. In a further example, user input from one or more devices or connected services may be employed alone, or in combination with an algorithm to determine a ranked list of possible objects in the line-of-sight of a subject. Image data may be associated with an image automatically according to algorithm parameters, user input, or a combination thereof.

The processes described herein for identifying line-of-sight and related objects of subjects in images and videos may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

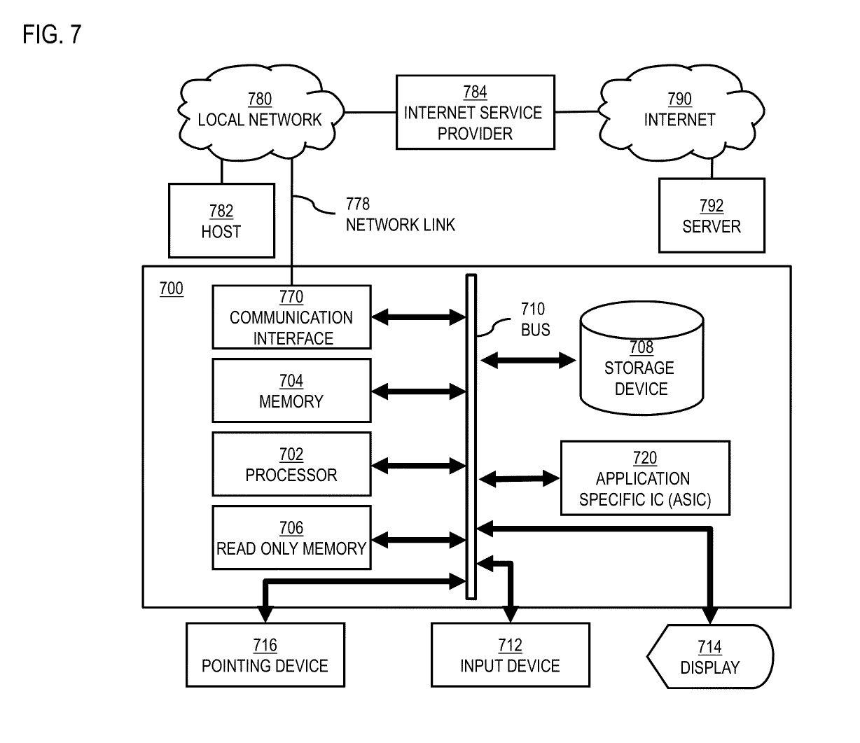

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to identify line-of-sight and related objects of subjects in images and videos as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of identifying line-of-sight and related objects of subjects in images and videos.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to identifying line-of-sight and related objects of subjects in images and videos. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for identifying line-of-sight and related objects of subjects in images and videos. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for identifying line-of-sight and related objects of subjects in images and videos, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for identifying line-of-sight and related objects of subjects in images and videos to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to identifying line-of-sight and related objects of subjects in images and videos as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of identifying line-of-sight and related objects of subjects in images and videos.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to identify line-of-sight and related objects of subjects in images and videos. The memory 805 also stores the data associated with or generated by the execution of the inventive steps.

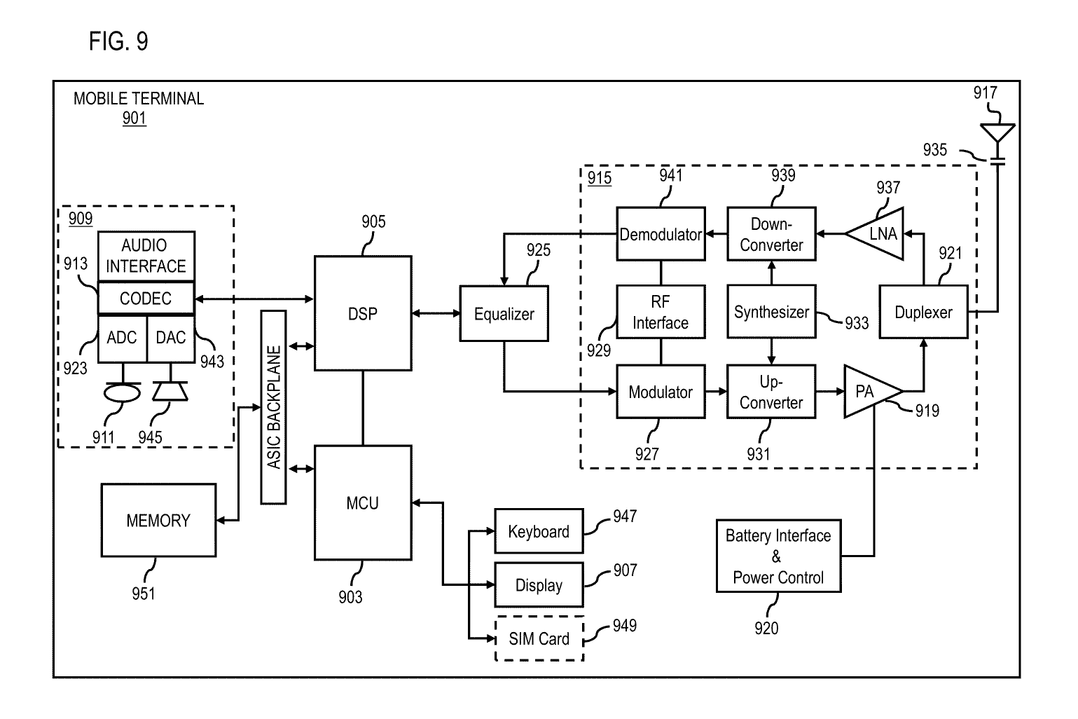

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of identifying line-of-sight and related objects of subjects in images and videos. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of identifying line-of-sight and related objects of subjects in images and videos. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to identifying line-of-sight and related objects of subjects in images and videos. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of the at least one image, sensor data, or a combination thereof to determine (a) at least one line of sight associated with at least one subject in the at least one image, (b) at least one object in the at least one line of sight, or (c) a combination thereof; and
an association of the at least one line of sight, the at least one object, or a combination thereof with the at least one image.

2. A method of claim 1, wherein the (1) data and/or (2) information and/or (3) at least one signal are further based, at least in part, on the following:
at least one determination of the sensor data from an imaging device capturing the at least one image, one or more other devices associated with the at least one subject, or a combination thereof.

3. A method of claim 2, wherein the (1) data and/or (2) information and/or (3) at least one signal are further based, at least in part, on the following:
a transmission of at least one synchronization signal to the device, the one or more other devices, or a combination thereof; and
a determination of the sensor data based, at least in part, on the at least one synchronization signal.

4. A method of claim 3, wherein the (1) data and/or (2) information and/or (3) at least one signal are further based, at least in part, on the following:
a capture of at least one other image of the at least one line of sight, the at least one object, or a combination based, at least in part, on the at least one synchronization signal; and
an association of the at least one other image with the at least one image.

5. A method of claim 4, wherein the capture of the at least one other image is via the at least one imaging device, the one or more other devices, or a combination thereof.

6. A method of claim 4, wherein the (1) data and/or (2) information and/or (3) at least one signal are further based, at least in part, on the following:
at least one determination of guidance information for instructing a user of the at least one imaging device, the one or more other devices, or a combination thereof for moving, configuring, or a combination thereof the at least one image device, the one or more other devices, or a combination thereof to cause the capture of the at least one other image; and
a presentation of the guidance information in a user interface of the at least one imaging device, the one or more other devices, or a combination thereof.

7. A method of claim 2, wherein at least one imaging device, the one or more other devices, or a combination thereof include, at least in part, a wearable device, a head-mounted device, or a combination thereof.

8. A method of claim 2, wherein the (1) data and/or (2) information and/or (3) at least one signal are further based, at least in part, on the following:
a processing of the sensor data to determine, at least in part, at least one location, at least one tilt angle, at least one field-of-view, or a combination thereof of the at least one imaging device, the one or more other devices, or a combination thereof; and
at least one determination of the at least one line of sight, the at least one object, or a combination thereof based, at least in part, on the at least one location, the at least one tilt angle, the at least one field-of-view, or a combination thereof.

9. A method of claim 1, wherein the (1) data and/or (2) information and/or (3) at least one signal are further based, at least in part, on the following:
at least one determination of one or more candidate objects based, at least in part, on the at least one line of sight; and
an input for specifying the at least one object from among the one or more candidate objects.

10. A method of claim 1, wherein the (1) data and/or (2) information and/or (3) at least one signal are further based, at least in part, on the following:
a querying for information related to an environment depicted in the at least one image, wherein the information includes real-time information, historical information, or a combination thereof; and
at least one determination of the at least one line of sight, the at least one object, or a combination thereof based, at least in part on the information.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of the at least one image, sensor data, or a combination thereof to determine (a) at least one line of sight associated with at least one subject in the at least one image, (b) at least one object in the at least one line of sight, or (c) a combination thereof; and
cause, at least in part, an association of the at least one line of sight, the at least one object, or a combination thereof with the at least one image.

12. An apparatus of claim 11, wherein the apparatus is further caused to:
determine the sensor data from an imaging device capturing the at least one image, one or more other devices associated with the at least one subject, or a combination thereof.

13. An apparatus of claim 12, wherein the apparatus is further caused to:
cause, at least in part, a transmission of at least one synchronization signal to the device, the one or more other devices, or a combination thereof; and
cause, at least in part, a determination of the sensor data based, at least in part, on the at least one synchronization signal.

14. An apparatus of claim 13, wherein the apparatus is further caused to:
cause, at least in part, a capture of at least one other image of the at least one line of sight, the at least one object, or a combination based, at least in part, on the at least one synchronization signal; and
cause, at least in part, an association of the at least one other image with the at least one image.

15. An apparatus of claim 14, wherein the capture of the at least one other image is via the at least one imaging device, the one or more other devices, or a combination thereof.

16. An apparatus of claim 14, wherein the apparatus is further caused to:
determine guidance information for instructing a user of the at least one imaging device, the one or more other devices, or a combination thereof for moving, configuring, or a combination thereof the at least one image device, the one or more other devices, or a combination thereof to cause the capture of the at least one other image; and
cause, at least in part, a presentation of the guidance information in a user interface of the at least one imaging device, the one or more other devices, or a combination thereof.

17. An apparatus of claim 12, wherein at least one imaging device, the one or more other devices, or a combination thereof include, at least in part, a wearable device, a head-mounted device, or a combination thereof.

18. An apparatus of claim 12, wherein the apparatus is further caused to:
process and/or facilitate a processing of the sensor data to determine, at least in part, at least one location, at least one tilt angle, at least one field-of-view, or a combination thereof of the at least one imaging device, the one or more other devices, or a combination thereof; and
determine the at least one line of sight, the at least one object, or a combination thereof based, at least in part, on the at least one location, the at least one tilt angle, the at least one field-of-view, or a combination thereof.

19. An apparatus of claim 11, wherein the apparatus is further caused to:
determine one or more candidate objects based, at least in part, on the at least one line of sight; and
determine an input for specifying the at least one object from among the one or more candidate objects.

20. An apparatus of claim 11, wherein the apparatus is further caused to:
cause, at least in part, a querying for information related to an environment depicted in the at least one image, wherein the information includes real-time information, historical information, or a combination thereof; and
determine the at least one line of sight, the at least one object, or a combination thereof based, at least in part on the information.

21-48. (canceled)
